(19) United States
(12) Patent Application Publication
(10) Pub. No.: US 2006/0092178 A1
(43) Pub. Date: May 4, 2006

(54) Method and system for communicating through shared media

(76) Inventors: Donald O. Tanguay JR., Sunnyvale, CA (US); Daniel G. Gelb, Redwood City, CA (US); Michael Harville, Palo Alto, CA (US); Henry H. Baker, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,428

(22) Filed: Oct. 29, 2004

(51) Int. Cl. G09G 5/00

(52) U.S. Cl. 345/629

(57) ABSTRACT

A method and system for communicating through shared media. Specifically, a method provides for accessing a plurality of images from respective input interfaces of a plurality of input interfaces. At least one of the plurality of images is captured using a camera, and wherein at least one of the plurality of images contains a form of communication. The form of communication is extracted from the plurality of images. A respective appearance model is constructed corresponding to each of the plurality of input interfaces. At least one of the respective appearance models contributes the respective form of communication that is extracted and transformed to a reference frame of a reference coordinate system. The respective appearance models are combined together to generate a shared virtual model. The shared virtual model is displayed to at least one output medium.

### TECHNICAL FIELD

The present invention relates to the field of multi-participant collaborative environments, and more particularly to a method and system for communicating through virtual collaborative media using cameras.

### BACKGROUND ART

A traditional collaborative meeting typically describes two or more participants meeting face-to-face at a central location (e.g., a room) for the purposes of discussion. Materials brought by each of the participants can be used to facilitate the transfer of information between the participants. For instance, a note pad brought by one of the participants can be used to take down notes, to present information that is shared between the participants, etc. Other materials that can be used include portable computers, scraps of paper, whiteboards, chalkboards, etc.

An extension of the traditional collaborative meeting is the use of a virtual communication environment to establish a virtual collaborative meeting. In that case, video communication can be used as an established method of collaboration between remotely located participants. In its basic form, a video image of a remote environment is broadcast onto a local monitor allowing a local participant to see and talk to one or more remotely located participants. The video images of the participants gives the sense of bringing the participants closer together, as if each of the participants was located with the other participants in a traditional collaborative meeting.

In both the traditional and virtual collaborative meeting environments, a shared communication platform can be used to communicate information to all the participants. For example, in a traditional collaborative meeting environment, a piece of paper, chalkboard, or whiteboard, etc., can be used by each of the participants to view and provide comments for input. In a typical scenario, one or more participants can be writing to the communication platform. For instance, the piece of paper can be passed between participants, or participants can take turns at a whiteboard for drawing images for discussion. Likewise, in a virtual collaborative environment for use between remotely located participants, various techniques have been implemented for the transfer of information. For instance, video cameras or computer input devices can be used to present contributions to shared virtual communication platforms. The contributions from the video cameras or the computer input devices are combined for display to each of the remote participants.

However, several problems exist with regards to the transfer of information via traditional or virtual communication platforms in the traditional or virtual collaborative environments, respectively. For instance, in the traditional collaborative environment, the participants need to share the communication platform. To avoid interfering with each other, participants usually take turns presenting inputs to the communication platform, e.g., taking turns with the piece of paper or taking turns at the whiteboard. As such, this limits the time of participation by each of the participants to the shared communication platform. Additionally, each of the participants needs to copy the information provided in the communication platform to his own notes. Because of time constraints errors can be introduced to the copies and the copies may be incomplete.

In the virtual collaborative environment, the participants typically need specialized equipment tailored to interacting with the shared virtual communication platform. For instance, special tablets are needed to interact with the video cameras so that the system can recognize the writing surface. Also, with computer input devices, each of the participants needs to bring or have access to computers and their interfaces (e.g., mouse, track ball, keyboard) in order to make contributions to the shared communication platform. As a result, the participant interfaces are unnatural, and require users to possess special equipment and special skills to interface with the systems implementing the shared communication platform.

In addition, in the virtual collaborative environment, the interfaces may introduce extraneous information that detracts from the pertinent information to be communicated. For instance, video cameras capturing images of the writing tablet interfaces for each of the participants could also capture the hands of the various participants as they write to their respective writing tablets. Imagery of these hands may incorrectly be displayed to other participants via the shared communication platform, even though the hands do not represent pertinent contributions to the communication.

Moreover, some conventional systems contain feedback loops involving cameras and displays that produce undesirable effects. For instance, when video cameras capture images writing surfaces that are also used as display surfaces (e.g., via projection) contributions made by a specific participant would be displayed back to the writing surface and recaptured again in a feedback loop for display. That is, the entire image of the writing surface would be captured for each of the participants as contributions to the shared communication platform, causing “ghost images of hands to appear on the display surfaces of participants. As a result, the feedback loop to each of the participants quickly degrades the image of the combined contributions, with the degradation becoming worse as more participants join in the communication. This prevents the collaborative communication system from scaling well to large numbers of participants.

Therefore, previous methods of implementing shared written communication platforms required specialized equipment, provided unnatural interfaces, provided extraneous information, and/or did not scale well to large numbers of participants, thus resulting in unsatisfactorily providing an input interface for participants to make contributions to the shared written communication platform.

### DISCLOSURE OF THE INVENTION

A method and system for communicating through shared media. Specifically, a method provides for accessing a plurality of images from respective input interfaces of a plurality of input interfaces. At least one of the plurality of images is captured using a camera, and wherein at least one of the plurality of images contains a form of communication. The form of communication is extracted from the plurality of images. A respective appearance model is constructed corresponding to each of the plurality of input interfaces. At least one of the respective appearance models contributes the respective form of communication that is extracted and transformed to a reference frame of a reference coordinate system. The respective appearance models are combined together to generate a shared virtual model. The shared virtual model is displayed to at least one output medium.

### BRIEF DESCRIPTION OF THE DRAWINGS

FIG. 1 is a block diagram of an exemplary system capable of communicating through shared media, in accordance with one embodiment of the present invention.

FIG. 2 is a flow diagram illustrating steps in a computer implemented method for communicating through shared media, in accordance with one embodiment of the present invention.

FIG. 3 is a data flow diagram illustrating the flow of information between multiple participants in a virtual collaborative environment, in accordance with one embodiment of the present invention.

FIG. 4 is a flow diagram illustrating steps in a computer implemented method for determining contributions of a local input interface, in accordance with one embodiment of the present invention.

FIG. 5A is an illustration of multiple cameras in one or more locations taking images of multiple input interfaces for contribution to a shared virtual model, in accordance with one embodiment of the present invention.

FIG. 5B is an illustration of one camera taking images of one or more input interfaces for contribution to a shared virtual model, in accordance with one embodiment of the present invention.

FIG. 5C is an illustration of two cameras taking a images that are combined of one input interface for contribution to a shared virtual model, in accordance with one embodiment of the present invention.

FIG. 5D is an illustration of an input interface being captured by two or more cameras as the input interface travels from the field-of-view of one camera to the field-of-view of another camera for contribution to a shared virtual model, in accordance with one embodiment of the present invention.

### BEST MODES FOR CARRYING OUT THE INVENTION

Reference will now be made in detail to the preferred embodiments of the present invention, a method and system of providing communication through shared media. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention can be implemented on software running on a computer system. The computer system can be a personal computer, notebook computer, server computer, mainframe, networked computer, handheld computer, personal digital assistant, workstation, mobile phone, and the like. This software program is operable for providing communication through shared media. In one embodiment, the computer system includes a processor coupled to a bus and memory storage coupled to the bus. The memory storage can be volatile or non-volatile and can include removable storage media. The computer can also include a monitor, provision for data input and output, etc.

Accordingly, the present invention provides a method and system for providing communication through shared media. In particular, embodiments of the present invention are capable of implementing shared communication platforms through interfaces that do not require possession of specialized equipment or skills by the participants. That is, the participants need only come to their respective meeting locations with a pen and paper, for example. As a result, embodiments of the present invention provide for natural interfaces in implementing the shared communication platform or media. As an added benefit, embodiments of the present invention are scalable because of the process implemented to reduce feedback information. As a result, embodiments of the present invention satisfactorily provide an input interface for participants to make contributions to a shared communication platform.

Additionally, embodiments of the present invention relate to the interchange and editing of information between participants in a multi-participant collaborative experience. That is, embodiments of the present invention allow multiple participants to interact and collaborate on a shared “virtual whiteboard” while requiring them to bring and setup a minimum of supporting equipment. For example, the participants could be using only those items that they would normally bring to a traditional collaboration meeting, such as a pad of paper and a writing instrument. In particular, embodiments of the present invention implements computer vision methods to determine what the participants have drawn on their respective input interfaces (e.g., writing surfaces). These data are then merged to form a shared, composite virtual model (e.g., virtual whiteboard), which is displayed back for all to observe via one or more display surfaces. In addition, embodiments of the present invention allow archiving, review, and summarization of the data from each participant and the resulting composite shared virtual whiteboard.

Communication through a Shared Virtual Model

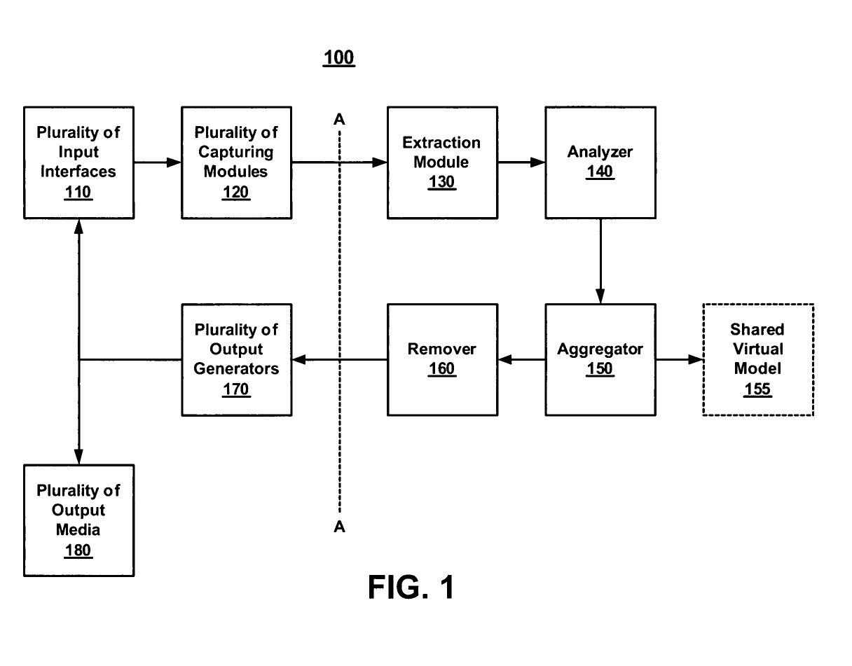

FIG. 1 is a block diagram of a system 100 that is capable of providing communication through shared media, in accordance with one embodiment of the present invention. System 100 is capable of capturing and editing information from a plurality of input interfaces 110, combining that information into a shared virtual model, and displaying and/or projecting representations of that model back to participants.

The system can be implemented within one or more locations. That is, the participants of a virtual collaborative experience can be located in one or more locations. In particular, to the left of line A-A, the participants that are associated with input interfaces and output media can be located in one or more locations. In that way, remote participants through the virtual shared model can participate with other remote participants as if they are located together in the same location. To the right of line A-A, the extraction module 130, aggregator 140, output generator 150, and the remover 160 are located in one location, in one embodiment. For instance a server computer may comprise and provide each of the functions of the extraction module 130, aggregator 140, output generator 150, and the remover 160. In addition, the extraction module 130, aggregator 140, output generator 150, and the remover 160 may be co-located with one of the plurality of input interfaces 110 to provide the dual functions of capturing and editing images from the input interfaces, as well as providing the interchanging and editing of information between participants in the multi-participant shared virtual collaborative experience.

In system 100, a plurality of input interfaces 110 provides the information or input from each of the participants in the shared virtual collaborative experience. In one embodiment, the plurality of input interfaces 1 10 is located at a local site. In another embodiment, the plurality of input interfaces 110 is located between at least two or more sites. Each of the plurality of input interfaces 110 provides a medium for accepting participant input. For instance, the medium may include writing instruments and surfaces. For example, writing instruments may include pencils, pens, permanent markers, dry-erase markers, and any other physical drawing implement. The surfaces upon which the writing instruments can transfer information include paper, dry-erase whiteboards, desks, walls, and any other physical drawing surface. The writing surfaces are typically rectangular, but may have any shape, such as a triangle, oval, or any other arbitrary shape. Embodiments of the present invention are capable of distinguishing the writing surfaces from background images for capturing participant inputs.

A plurality of capturing modules 120 captures the plurality of images from respective input interfaces. At least one of the capturing modules includes a camera system. Each of the plurality of images can present contributions to a shared virtual model which each of the participants can view and interact with. Camera/surface arrangements can take several forms. In one embodiment, there is a single camera per input interface (e.g., writing surface). In another embodiment, a single camera may capture imagery for more than one writing surface. In yet another embodiment, multiple cameras may capture imagery for a single writing surface.

The system 100 also includes an extraction module 130. The extraction module 130 is capable of extracting contributions made by each of the participants through respective input interfaces. That is, the extraction module 130 extracts selected contributions from images associated with a selected input interface. As will be described in detail below, the extraction module is capable of distilling the information to provide only contributions made by respective participants, and not other extraneous information, such as background information, transient objects (e.g., hands), etc. That is, the extraction module 130 is also capable of extracting non-communicative forms from the input interfaces and discarding them.

The system 100 also includes an analyzer 140 for constructing a respective appearance model corresponding to each of the plurality of input interfaces. As will be described in detail below, the analyzer 140 constructs a respective appearance model for each of the plurality of input interfaces 110, wherein each of the appearance models is later mapped to a reference coordinate system corresponding to a shared virtual model.

An aggregator 150 combines one or more of the respective appearance models corresponding to each of the plurality of input interfaces 110 to create and output a shared virtual model 155 (e.g., a shared virtual whiteboard). In one embodiment, the aggregator 150 outputs a single image or video stream merging and combining one or more of the respective appearance models together to generate the shared virtual model 155. In another embodiment, the aggregator 150 layers one or more of the respective appearance models together to generate the shared virtual model 155. In both cases, the shared virtual model 145 includes some or all of the contributions made by each of the selected participants through respective input interfaces. The aggregator 150 provides the output for displaying the shared virtual model to at least one output medium.

The system 100 optionally includes a remover 160 for subtracting selected contributions from the shared virtual model 145. That is, the remover 160 is capable of removing or omitting contributions made by each of the plurality of input interfaces so that those contributions are not superimposed onto identical images when projecting the shared virtual model 145 back onto a corresponding input interface.

A plurality of output generators 170 receives the output from the aggregator 150 or remover 160 to convey images of the shared virtual model 155 to the participants. In one embodiment, the shared virtual model 155 is sent to a plurality of digital output media 180 (e.g., displays, plasma screen, laptop computer, or tablet computer, etc.). The shared virtual model 155 includes all the contributions from each of the participants. In another embodiment, at least one of the output media comprises at least one of the plurality of input interfaces 110. That is, at least one projector projects the shared virtual model 155 back onto a corresponding input interface. In this case, the shared virtual model 155 projected to the corresponding input interface includes all the contributions from each of the participants minus the contributions made from the corresponding input interface.

In another embodiment of the present invention, a tracker coupled to one of the plurality of input interfaces is included within system 100. The tracker finds the input interface in the imagery even while the input interface may be casually moved or rotated within the field of view of a single camera. The movement of the input interface is visually measured so that its contents may be re-aligned with those of the shared virtual model. The tracker also tracks the input interface to enable images associated with that input interface to be captured by multiple camera systems or capturing modules in succession. This hand-off from a first camera to a second camera would happen, for example, if the second camera were to obtain better visibility of the input interface than the first camera.

In another embodiment of the present invention, the tracker is coupled to a projector and is capable of tracking an input interface within its field-of-view. This allows for adaptation of projection onto the input interface as it is casually moved or rotated within the field of projection of a single projector so that it the representation of the shared virtual model appears to move along with the input interface. The tracker may also track the input interface as it moves through the fields of projection of multiple projectors in succession. This allows the tracker to correctly project the shared virtual model 155 onto the input interface in alignment with the coordinate system of the input interface as the input interface travels out of the field-of-view of one projector and into the field-of-view of another projector, as will be described more fully below.

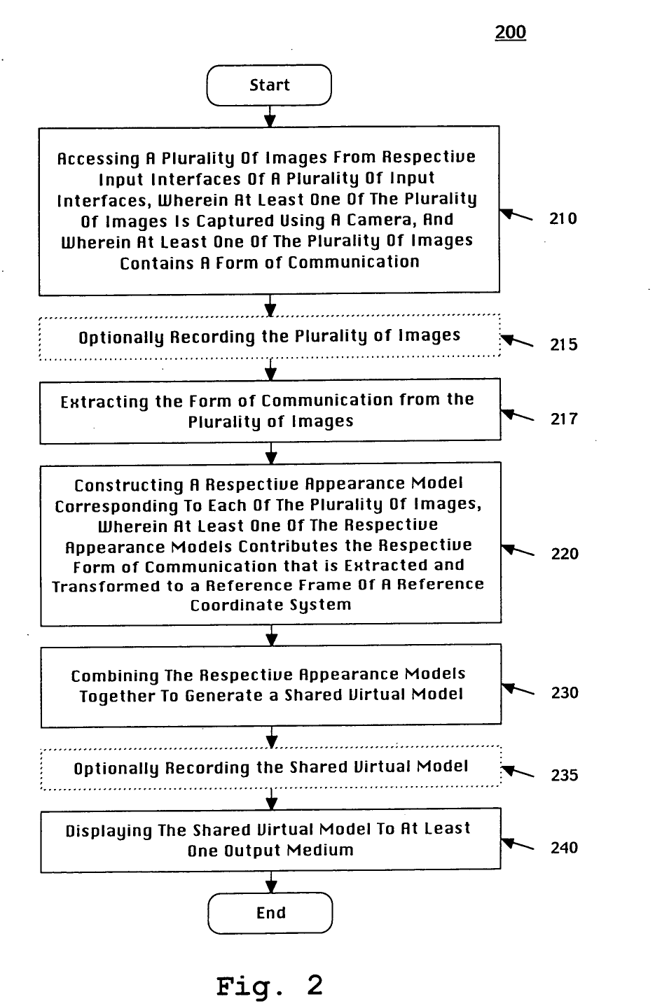

FIG. 2 is a flow chart 200 illustrating a computer implemented method for providing communication through shared media, in accordance with one embodiment of the present invention. The flow chart 200 provides for multiple participants to interact and collaborate on a shared communication platform or model (e.g., virtual whiteboard) while requiring them to bring and setup a minimum of supporting equipment. For instance, multiple participants can participate in a collaborative meeting in which each of the participants view and can simultaneously interact with the shared virtual model for enabling communication.

In one embodiment of the present invention, the method of flow chart 200 is implemented within the context of a rich media environment. Other embodiments of the present invention are well suited to uses within other environments, such as distance learning, electronic gaming and gambling, digital television, and other entertainment scenarios.

In one embodiment, a rich media environment includes an arrangement of sensing and rendering components. The sensing components in the rich media environment may include any assortment of microphones, cameras, motion detectors, etc. Input devices, such as keyboards, mice, keypads, touchscreens, etc., may be treated as sensing components. The rendering components in the rich media environment may include any assortment of visual displays and audio speakers. The rich media environment may be embodied in any contiguous space. Examples include conference rooms, meeting rooms, outdoor venues, e.g., sporting events, etc. The rich media environment preferably includes a relatively large number of sensing and rendering components, thereby enabling flexible deployment of sensing and rendering components onto multiple communication interactions. Hence the term—rich media environment.

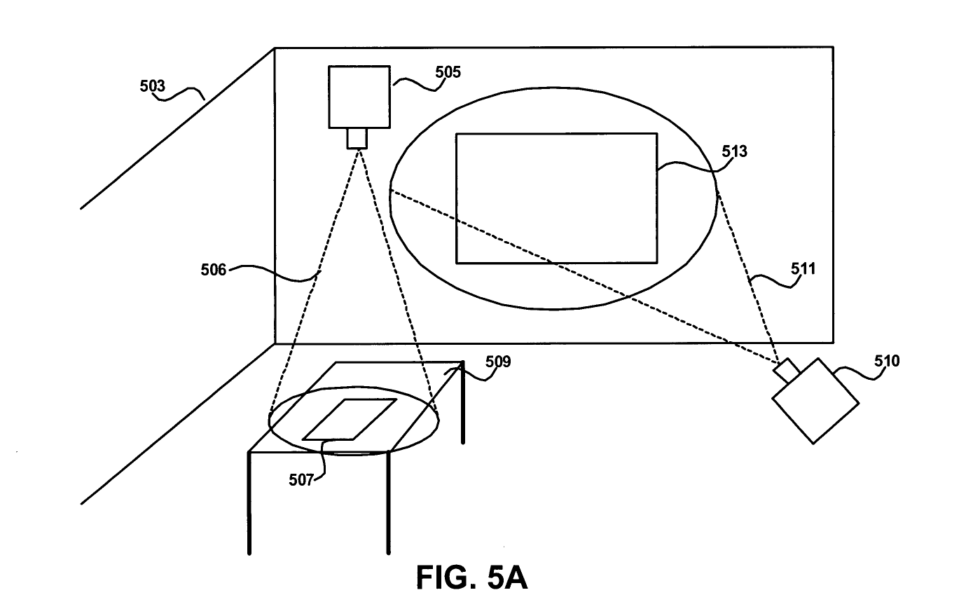

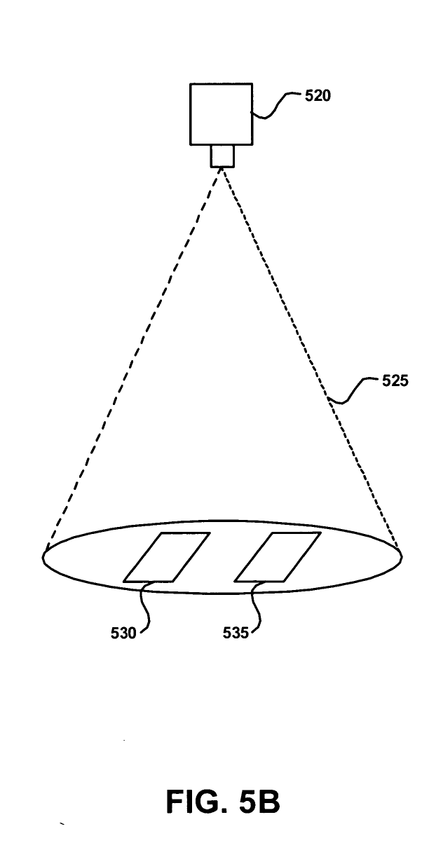

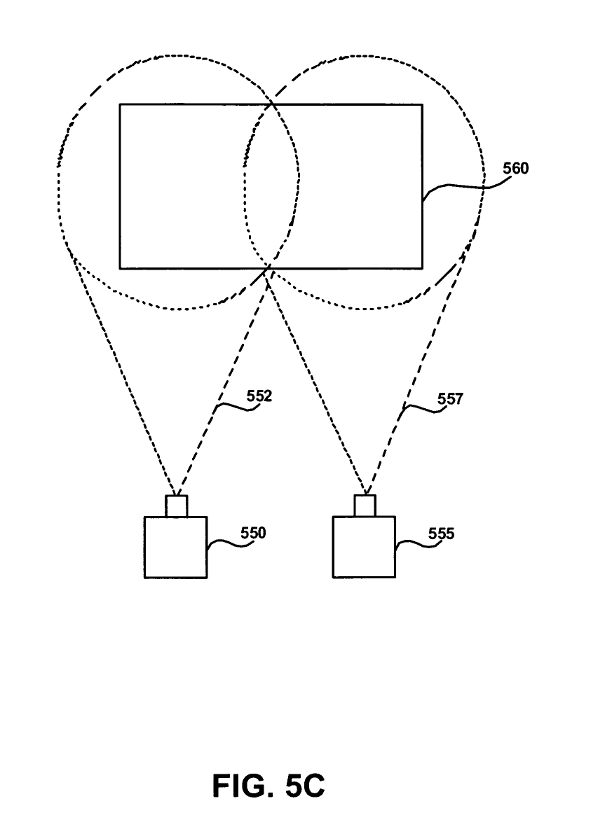

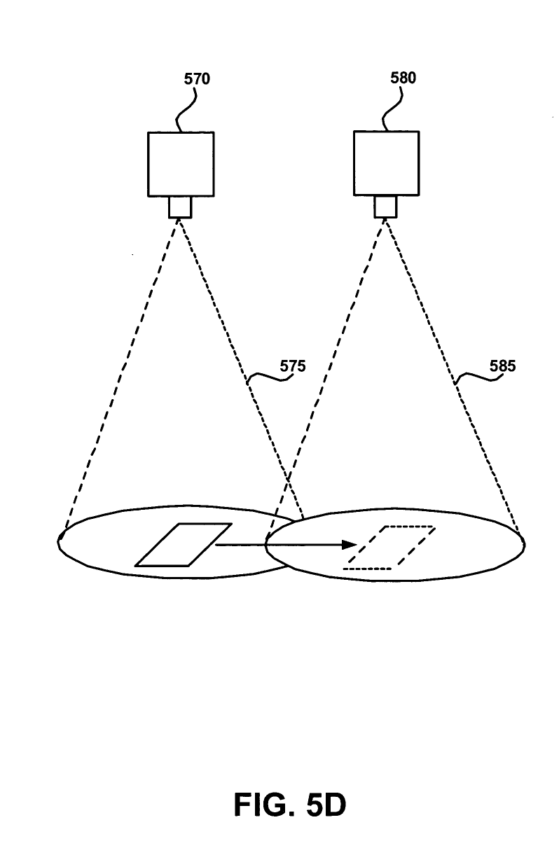

At 210, the present embodiment accesses a plurality of images from respective input interfaces of a plurality of input interfaces. That is, each input interface (writing surface, paper, notepad, computer input device) is associated with an image or image sequence that may contain contributions of an associated participant to a shared virtual model (e.g., virtual whiteboard). Each of the plurality of images may contribute respective forms of communication to a shared virtual model. Specifically, at least one of the plurality of images contains a respective form of communication. In addition, each of the plurality of images may include non-communicative contributions, such as hand images, smudges on paper or on a physical whiteboard, etc. More particularly, at least one of the plurality of images is captured using a camera system, as will be described more fully below with respect to FIGS. 5A, 5B, 5C, and 5D. In other embodiments, computer vision techniques are used to track the motions of the writing instrument. The writing instrument may or may not leave marks on the writing surface, or input interface. Such motions might be used for drawing or erasing.

As described previously, the input interface can be located at one or more sites. In that way, a virtual collaborative meeting can be established in which participants located in one or more sites can simultaneously view and interact with a shared virtual communication platform, or model (e.g., virtual whiteboard).

At 215, the present embodiment optionally records the plurality of images. As a result, the contributions made by each of the participants can be separately stored and archived, for later retrieval and manipulation.

At 217, the present embodiment extracts at least one of the forms of communication from the plurality of images. More specifically, the present embodiment extracts the respective form of communication from the plurality of images. The present embodiment also extracts non-communicative contributions that are discarded, or ignored. For instance, non-communicative contributions can include background images, images of the writing instrument, images of hands, smudges, etc.

At 220, the present embodiment constructs a respective appearance model corresponding to each of the plurality of images. That is, each of the respective appearance models describes respective forms of communication that are extracted from a corresponding input interface having a corresponding input coordinate system. These forms are transformed to a reference frame of a reference coordinate system. Specifically, at least one of the respective appearance models contributes the respective form of communication that was extracted and transformed to the reference frame of the reference coordinate system. For instance, once the input interface (e.g., writing surface) has been identified to define a boundary of an input coordinate system, the writing surface can be parameterized by the input coordinate system to describe locations on that surface. Then, the present embodiment rectifies the subset of the image or video sequence corresponding to the input interface into a single rectangular reference coordinate system. That is, once the boundaries of the input interface are determined, the image can be translated into a respective appearance model that is later mapped to the reference coordinate system.

As such, each input interface is associated with an input coordinate transformation which describes the relationship between points in the input interface and points in the reference coordinate system. In that way, contributions from each of the plurality of input images can be placed into respective appearance models transformed to a reference coordinate system. This facilitates the combining and layering of contributions associated with each of the plurality of input interfaces within a common reference frame. Furthermore, the input coordinate systems, reference coordinate systems, as well as the output coordinate systems can be two-dimensional (e.g., Cartesian planar, polar, or cylindrical) or three-dimensional (e.g., spherical solid).

In particular, in order to determine contributions from a particular input interface (e.g., writing surface), an appearance model of the input interface must be constructed. For instance, this appearance model is a depiction of the physical writings on a writing surface and is constructed using analysis and synthesis techniques known in the art of computer vision. The appearance model is expressed in the reference coordinate system to facilitate the merging of all contributions from each of the input interfaces. The appearance model may be simply an image of the writing surface rectified into the reference coordinate system, or it may be a list of geometric drawing commands representing a collection of individual drawing strokes, or an alternative representation.

In one embodiment, to determine the contributions of an input interface, computer vision algorithms for background modeling compute the difference between a model of the original writing surface and the current marked-up surface to isolate the contributions. Many techniques for video background modeling and removal, such as those based on differencing with a stored mean image of the scene or with an adaptive per-pixel Gaussian mixture model, are known in the art of computer vision and may be used in this embodiment. Before a participant begins writing on his respective writing surface, an initialization process can be performed to obtain an initial image of the surface to be used as a reference for measuring future modifications. For example, a standard background differencing technique can be used to identify and group differences between the initial image and a later image containing written contributions to form the appearance model of this writing surface. That is, the present embodiment is able to subtract background images from the image captured at an input interface.

In particular, during the initialization process, a snapshot of the writing surface is taken in order to define “blankness” of the surface. Even if the initial image of the surface captures dirt, smudges, previous markings or a printed document lying on it, the appearance model is empty until something changes from the initial state. For instance, this allows a participant to write on a previously used sheet of paper as though it were a blank sheet of paper. Only when the participant modifies the appearance of the paper (as by writing) do markings begin to appear in the appearance model.

Another embodiment of the present invention identifies and avoids non-surface objects in the images of the video sequence of the input interface. For example, as a participant writes on the surface with a writing instrument, it is preferable that neither the participant, the participant's hand, nor the writing instrument itself show up in the appearance model of that writing surface. Several techniques known in the art of computer vision can be used to avoid putting such non-surface objects into the appearance model. For instance, one embodiment is capable of detecting and tracking regions of motion in front of the writing surface and avoids capturing data at or near such locations.

In another embodiment, new writings must remain consistent for some minimal period of time after their first appearance before being added as an input to the shared virtual model. That is, after the appearance model is initialized as empty, updates to the appearance model are added as contributions only in regions where imagery of the writing surface is stationary (e.g., no motion has been detected in that region for more than one second).

Furthermore, in other embodiments, the resulting video sequence of the appearance model, rectified to the reference coordinate system, can be further analyzed to remove stationary non-writings (e.g., remove the white background of the whiteboard) or enhance the writings (e.g., saturate the colors so that the blue markings look brighter or perform super-resolution algorithms to increase the image resolution).

Continuing with FIG. 2, at 230, the embodiment of flow chart 200 also combines the respective appearance models together to generate a shared virtual model. That is, once the appearance model of each writing surface has been constructed, the models are incorporated into the shared virtual model (e.g., virtual whiteboard). Because the appearance models are expressed in the reference coordinate system, it is straightforward to map all of them into a single model. In one embodiment, the shared virtual model is a single image formed by simple composition of the appearance models. In another embodiment, the shared virtual model consists of layers, wherein the appearance of the shared virtual model is a combination of one or more selected layers. Specifically, each layer may correspond to a particular writing surface.

Using a layered model allows for the introduction of scanned figures or documents as additional layers. For instance, by way of illustration, a participant would (1) draw on a writing surface or place a document on the writing surface; (2) indicate (via gestures or other controls) that the image needs to be scanned by the capturing system; and (3) remove the drawing or document. The capturing module is capable of scanning and storing the image in a new layer that is separate from the layer corresponding to the writing surface. This new layer can become part of the shared virtual model that is shared with all participants.

In another embodiment, some or all of the respective appearance models are merged and combined together to form one image or video sequence of images. The merged contributions form the shared virtual model.

At 235, the present embodiment optionally records the shared virtual model. By storing the shared virtual model, a historical timeline can be created illustrating a history of the changes made to the shared virtual model, as will be described more fully below. Moreover, in the case where the shared virtual model is comprised of layers, each of the layers can be separately recorded. In that way the layers can be selected individually for later access or combination.

At 240, the present embodiment displays the shared virtual model to at least one output medium. That is, the shared virtual model is presented for viewing by the participants of the collaborative session. In one embodiment, at least one input interface physically coincides with an output medium. That is, the shared virtual model is superimposed onto at least one of the plurality of input interfaces. For example, the shared virtual model may be projected directly upon the input interface. In this case, the input interfaces (writing surfaces) double as displays, so that the viewing participant may also modify the shared contributions in the shared virtual model.

The present embodiment adjusts the shared virtual model to fit within a display frame of the output medium. That is, the shared virtual model is translated from dimensions in the reference coordinate system to the display frame of an output coordinate system. For instance, a translator in system 100 of FIG. 1 adjusts the dimensions of the shared virtual model to fit within a display frame of the output medium.

For participants making use of physical boards or pieces of paper to provide input (via observation by cameras), their physical writing surfaces may be made to also serve as displays through use of digital projectors. In this case, if there are N total input interfaces being used by the participants, a composite image of the contributions of the N-1 other input interfaces is projected onto the local, physical writing surface of a given participant. This projection, together with the local, physical writing, forms a complete composite image of all N input interfaces. Moreover, a tracker (described previously) updates the output coordinate transform between the output device (projector onto a surface) and the reference coordinate system to keep the projected image and local writing properly aligned. Within this scenario, video analysis can be used to prevent the shared virtual model from being displayed on objects that occlude the board, such as the participant's hands.

In another embodiment, the output medium is distinct from the input interface. Specifically, in the virtual collaborative session, the merged contributions of the shared virtual model must be displayed to the participants. In some embodiments, these contents are displayed at locations distinct from the input interfaces, so that participants can view the shared virtual model at this display but cannot modify its content there. This can be done utilizing a plasma screen, an LCD display, a projector directed at a white screen or board, or some other type of visual presentation medium.

In still other embodiments, for participants providing input through a traditional computer interface, such as a touch-screen or tablet computer with stylus or mouse, the shared virtual model can be recreated on the display of the computer interface by reproducing the marks made by others within the same software application into which these participants are drawing. These new contributions in the shared virtual model are aligned properly with the participant's own markings through use of output coordinate transforms between the reference coordinate system of the shared virtual model and the output coordinate system of the output display. Since the input and output device is identical in this case, the corresponding input and output coordinate transforms are inverses of each other.

In another embodiment of the present invention, contributions made on a local input interface are omitted from display on the output medium coincident with that input interface. In particular, the contributions to the shared virtual model made from the selected input interface are identified. Then, the present embodiment subtracts the identified and selected contributions from the shared virtual model. In that way, the selected contributions are not superimposed onto the selected input interface when the shared virtual model is displayed on the selected input interface. More particularly, the present embodiment is capable of separating what has been drawn locally on a particular writing surface from inputs from other sources that may be displayed or projected onto this surface. Since the relative configuration of a capturing module, projector, and/or display surface related to an input interface is determined, and since what is being projected is known, the present embodiment is able to distinguish the projected data from the local writing. Also, a special pattern can be projected, or the projector can be turned off very briefly to allow the camera to capture the writing surface without the projected image in order to isolate the local writings. Furthermore, alternating phases of projection display and image capture can facilitate the separation.

In a layered technique of generating the shared virtual model, all layers can be overlaid and projected back onto one of the original input interfaces. In this case, it is preferable to remove the layer corresponding to this surface in order to avoid re-projection of the local, physical writings on that surface. Not only does this avoid duplication of the same writings (one projection, the other physical), but also it avoids possible quality artifacts if the two are slightly misaligned.

In another embodiment, it is preferable to avoid projecting onto a participant's hand as they are drawing on the input interface. This can be distracting for the participant. In one embodiment, hand-tracking techniques are used to identify the location of the participant's hands in the images. Many hand tracking techniques are known in the art of computer vision and are suitable for operation in this embodiment. As a result, the projection of the shared virtual model is not projected where the hands are located. In another embodiment, the image is analyzed to find regions with a color similar to human skin. Many skin color identification techniques are known in the art of computer vision and are suitable for operation in this embodiment. The projectors are controlled to avoid projecting onto these regions, which are assumed to be the hand or other parts of the body.

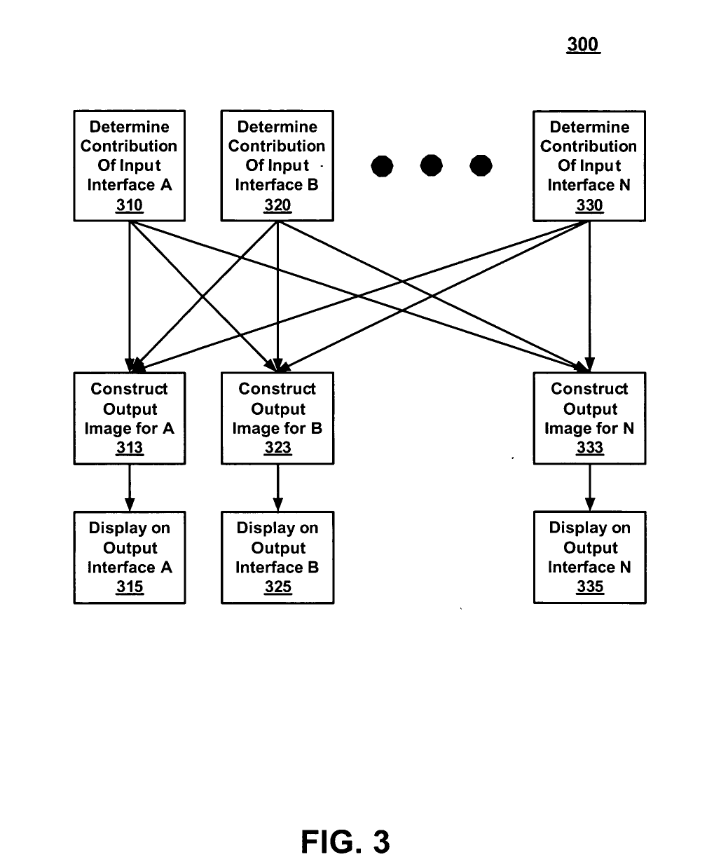

Referring now to FIG. 3, a data flow diagram 300 is shown illustrating the flow of information between participants in a virtual collaborative session that provides communication through a shared virtual model, in accordance with one embodiment of the present invention. The present embodiment is scalable in that the data flow diagram 300 is representative of N participants within a virtual collaborative session. In addition, the input interfaces A through N can be located in one or more sites. In that way, contributions from each of the input interfaces can be combined into a shared virtual model to facilitate a virtual collaborative session.

At each of the input interfaces A through N, contributions are captured. For instance, at block 310, the contributions to input interface A are determined, as described previously. Also, at block 320, the contributions to input interface B are determined. Similarly, at block 330, the contributions to input interface N are determined.

Each of these contributions is shared between the participants. For instance, the contribution of input interface A is presented to interface B at block 323 and to interface N at block 333. Also, the contribution of input interface B is presented to interface A at block 313 and to interface N at block 333. Additionally, the contribution of input interface N is presented to interface A at block 313 and to input interface B at block 323.

As a result, since all the contributions from each of the input interfaces are presented to each of the input interfaces A through N, appropriate output images for each of the input interfaces A through N can be constructed. For instance, at block 313, contributions from each of the input interfaces A through N are combined to construct a shared virtual model for display as an output image on input interface A. As described previously, the shared virtual model may remove or omit contributions made at the input interface A to reduce artifacts, or ghosting, etc. when displaying the shared virtual model on input interface A. Similarly, at block 323, contributions from each of the input interfaces A through N are combined to construct a shared virtual model for display as an output image on input interface B. Also, at block 333, contributions from each of the input interfaces A through N are combined to construct a shared virtual model for display as an output image on input interface N. Thereafter, at blocks 315, 325, and 335, the output images are displayed at their respective input interfaces.

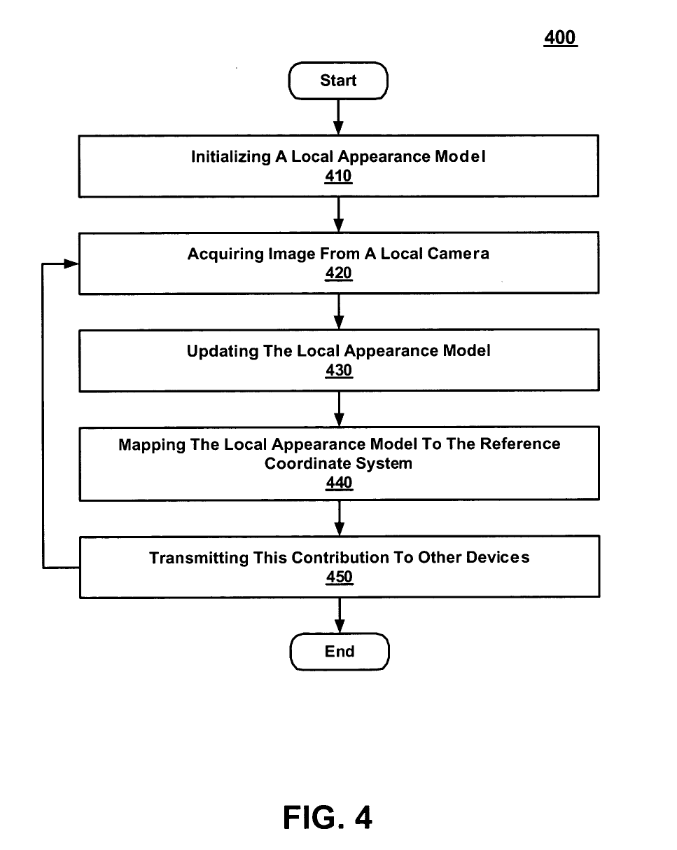

FIG. 4 is a flow chart 400 illustrating steps in a computer implemented method for forming contributions at a selected input interface that are presented as an input to a shared virtual model in a virtual collaborative session, in accordance with one embodiment of the present invention. At 410, the present embodiment initializes a local appearance model, as described previously. In this way, a blank appearance model can be initialized as the original appearance of the input interface so that future markings can be distinguished as contributions. Initialization can occur at any time. For instance, the initialization process may occur after the input interface disappears from camera view and reappears after a period of time. At 420, the present embodiment acquires images of the input interface from a local camera, as described previously. In this way, contributions made to the input interface can be captured. At 430, the present embodiment updates the local appearance model to include the contributions made to the input interface. At 440, the present embodiment maps the local appearance model from a respective input coordinate system to a reference frame of a reference coordinate system. In that way, contributions from all the different input interfaces can be easily layered and combined since they are all of the same dimension. At 450, the present embodiment transmits the reference-mapped contributions captured at the input interface to the other devices, or input interfaces, so that this contribution can be included within the shared virtual model that is displayed at those other input interfaces. From block 450, the present embodiment returns to block 420 to continually process the images from the local camera. As such, current contributions to the shared virtual model through the input interface can be accounted for and made.

FIGS. 5A, 5B, 5C, and 5D are exemplary illustrations of various scenarios within which to capture images from input interfaces, in accordance with embodiments of the present invention. In the collection of FIGS. 5A, 5B, 5C, and 5D, camera systems are described for capturing the images of the input interfaces. However, other embodiments are well suited to other capturing means for capturing the images from the input interfaces.

FIG. 5A is an illustration of a one-to-one relationship between a camera system and an input interface, in accordance with one embodiment of the present invention. Camera/surface arrangements can take several forms. In the present embodiment, there is a single camera per writing surface. Each camera delivers a video sequence for one and only one writing surface.

As shown in FIG. 5A, the collaboration participants associated with the input interfaces are located at the same physical site, room 503. Two or more writing surfaces (e.g., input interfaces 507 and 513) at the site are used to communicate input to the shared virtual model. For instance, a participant may write on a piece of paper represented by input interface 507 that is located on a surface of table 509. Also, another participant may provide input to a whiteboard, represented by input interface 513, that is mounted on the wall. As shown in FIG. 5A, the input interface 507 is located in front of the input interface 513 from the view of the room 503.

As shown in FIG. 5A, camera system 505 is mounted to the ceiling and captures images of the input interface 507. The input interface 507 is well within the field-of-view of the camera system 505. Also, the camera system 510 captures images of the input interface 513 that is mounted on the wall. The input interface 513 is well within the field-of-view of the camera system 510.

While the input interfaces of FIG. 5A are located in one site, other embodiments are well suited to locating the input interface 507 and the input interface 513 at different locations. In that case, the collaboration participants of a virtual collaborative session are located at more than one physical site, and the shared virtual model enables collaboration both within and across these sites. In this case, network connectivity provides communication between distinct physical sites, so that writings of people at different sites are merged into a single set of shared virtual model contents that are then displayed to all participants at all sites.

If the camera system 505 is not naturally positioned and zoomed so that the entire video sequence contains the input interface 507, it is necessary to detect and extract the writing surface from a subset of the video field of view 506. The detection of the input interface 507 may be done automatically or manually. In the case of automatic detection, techniques known in the art of computer vision can be employed to find visual patterns associated with writing surfaces, such as rectangular edge boundaries, specifically-colored boundaries, large homogeneous regions, special bounding box symbols, etc. Alternatively, a more manual method of detecting the input interface 507 (e.g., writing surface) can be employed to define the bounds of the valid drawing area. For example, the participant may draw a rectangular box on the input interface 507 to indicate that the interior region should be considered as a valid input interface. As another example, the participant may draw symbols or other indicia to specify the corners of the valid drawing area of the input interface. In these examples, techniques known in the art of computer vision can be employed to find the corners of the drawn rectangular box, the drawn symbols, or other indicia drawn by the user, so that the boundaries of the input interface may be determined.

FIG. 5B illustrates a situation where one camera system captures two or more input interfaces, in accordance with one embodiment of the present invention. In FIG. 5B, a camera system 520 with sufficient resolution captures two writing surfaces, input interfaces 530 and 535. That is, the field-of-view of the camera system 520 is large enough and has sufficient resolution to distinguish and capture both input interfaces 530 and 535 in a single video sequence, or image. The present embodiment can employ techniques known in the art of computer vision to separate the video sequence into two video sequences, each containing the visual data of the corresponding writing surface.

FIG. 5C illustrates a situation where multiple cameras can be used to capture a single input interface. For instance, the input interface 560 may be a large board mounted on the wall of a conference room. The field-of-view 552 of the camera system 550 only covers the left half of the input interface 560. The field-of-view 557 of the camera system 555 covers the right half of the input interface 560. The two fields-of-view have some overlap in the center of the input interface 560. Techniques known in the art of computer vision (e.g., linear homographies and image blending) can be used to combine the video sequences from the two camera systems 550 and 555 into one video sequence that contains the visual data of the input interface 560.

In another embodiment, multiple cameras are used to capture a single input interface. This is especially useful when a participant is allowed to move and rotate the surface of the input interface arbitrarily. For instance, the participant may remove the input interface from a desk and rest it on his or her knee for a more comfortable seating position. A tracker is used to select, from among a plurality of cameras, the camera having the best view of a particular region of the surface. As such, the camera with the best view may change as the writing surface moves through the fields-of-view of the camera. Some of the cameras may have fixed locations and viewing directions in the environment, while others may have motion controls (e.g., pan, tilt, and zoom) in order to better capture an input interface that moves.

In FIG. 5D, if the input interface is allowed to move, the input coordinate transformation must continually adapt in order to correctly rectify the image of the writing surface. For instance, camera system 570 with field-of-view 575 can be used to capture images from the input interface 590 at time t-0. However, as the input interface 590 travels out of the field-of-view 575 and into the field-of-view 585 at time t-1, camera system 580 can be used to capture images from the input interface 590. Tracking methods known in the art of computer vision can be used to continually detect the presence, position, and orientation of the input interface 590 in the video sequence. In addition, using well-known super-resolution techniques while tracking the motion of the input interface 590 can increase the resulting image resolution. In that way, slight variations in the position of the input interface 590 can lead to better sampling of the writing surface, and images can be generated with higher resolution than the native resolution of the cameras.

If the input interface moves (as it would if the surface were a normal pad of paper on a table), the system needs to adapt by computing the new output transformation when displaying the shared virtual model back onto the input interface. That is, one or more cameras can be used to track the position and orientation of the writing surface. The output transformation is determined depending on which camera is currently viewing the input interface and which projectors will be used to project onto it. If the range of allowed motion is large enough, additional projectors can be used to provide further display coverage. For example, a pad of paper may first be projected upon by one projector, but may fall out of the range of the projector as it moves away. A second projector can increasingly provide the output image as it gains better coverage of the surface. Allowing the projectors to move (e.g., pan, tilt, and zoom) provides even more flexibility in projecting a good image onto the surface of the input interface.

Although embodiments of the present invention as shown in FIGS. 5A, 5B, 5C, and 5D show camera systems capturing images from input interfaces (e.g., writing surfaces), other embodiments of the present invention can utilize any type of interface for capturing participant input. For example, computer sketch programs running on networked computers can be used to capture input. These sketch programs might allow the participant to draw or to type text via tools such as a computer mouse, a keyboard, or a touch-sensitive display. Other interfaces have included methods for tracking the movement of physical pens on real whiteboard surfaces, using techniques such as ultrasound or infrared tracking.

Gestural Control Interface

In another embodiment, in addition to capturing contributions, the plurality of capturing modules 120 (e.g., cameras) may also be used to recognize gestures made by the participants. These gestures can be used as control mechanisms to implement various types of system functionality.

Many well-known techniques exist for extracting silhouettes of hands against known or unknown backgrounds, for recognizing configurations of the hands from these silhouettes, and for finding fingers or other extremities in these silhouettes. In one embodiment, the extraction module 130 provides the necessary functionality for extracting the silhouettes of the hands. A model of the background may be necessary for extracting the silhouettes of the hands. For instance, the local appearance model essentially represents how the surface of the input interface appears, including any writings that have been made upon it, when no person or other moving scene objects obstruct the camera's view of the surface, and is therefore akin to the background models commonly constructed in computer vision applications. Standard methods of comparison with the background model yield an image map representing the regions of foreground in the scene, which are typically associated with either new writings or with parts of one or more people who are obstructing the surface. Silhouettes of these foreground regions are extracted via standard methods. The shapes of the silhouettes are analyzable by standard methods to distinguish, with high reliability, portions of outstretched hands, arms, and fingers from other body parts or from whiteboard writings. These hand, arm, and finger silhouettes may be further analyzed by known methods to detect, based on curvature and other measures, extremities corresponding to finger or hand tips. In one embodiment, the analyzer 140 provides the necessary functionality for analyzing the silhouettes. To distinguish intentional gestures from quick movements across the writing surface or image input noise, parameters (such as location and configuration) of a detected hand and/or finger silhouette are required to remain stable for some minimum period of time, or must change smoothly with some maximum rate over time.

Detection of a stable and interesting silhouette may itself be interpreted as a gesture, and may trigger an action, such as placing an attention-grabbing mark at the detected gesture location. Alternatively, once a stable and interesting silhouette is detected, its motion may be tracked to allow more powerful gestures. For instance, motion of a hand with an outstretched finger may be tracked until it forms a closed curve, at which point an action may be applied to the contents of the shared virtual model within the closed curve.

In another embodiment, gestural control over the work surface defined for a participant may preferentially be expressed within an established hand signaling system (e.g., American Sign Language) which may be automatically recognized through video image processing.

Erasing of Whiteboard Writings

Meeting participants using camera-based capture of physical writing surfaces as input interfaces may wish to erase any or all of the current contents of the shared virtual model. The participants may wish to erase not just their own writings, but also those made by others.

In one embodiment, contributions made by a participant can be removed from the shared virtual model by erasing or removing those contributions on the input interfaces associated with the participant. The camera and analyzer observing the participant's input interface detects the absence of writings made at a previous time, and removes these writings from the shared virtual model. Subsequent renderings of the shared virtual model on all displays would not include the contributions that were erased.

In some embodiments, a special physical tool is used to do the erasure. This tool must be visually recognizable and trackable by the camera system, and therefore should be somewhat visually distinctive. For instance, the tool may be a flat, black object of a distinctive shape such as a hexagon or circle. Alternatively, it may be a stylus with one end that has a distinctively colored (e.g. bright red or blue) ball at one end of it. To erase a portion of the whiteboard contents, a participant simply places the tool on any physical writing surface being observed by one of the cameras, and moves the tool to cover or encircle the area to be erased, all the while being careful not to greatly obstruct with his hand the camera's view of the tool. Contents covered and/or encircled by the tool are removed from all displays of the shared virtual model content.

If the participant using the erasure tool is attempting to remove markings that were made on the same surface to which the erasure tool is currently being applied, then it is preferable that the erasure tool also be capable of erasing the physical marks made on the physical surface of the input interface. For instance, for a whiteboard, it is preferable that the side of the erasure tool that is pressed against the whiteboard is able to efficiently remove the whiteboard marker writings on that whiteboard as the tool is moved. Similarly, for pencil marks on paper, it is preferable that the erasure tool possesses a standard pencil eraser at the end pressed against the paper. Without this physical erasure of the underlying physical input interface writings, the content erased from the shared virtual model will continue to be visible to the participant of the input interface on which they were drawn, but to no one else. The camera observing this input interface must then also continue to ignore these virtually erased contents as it continues to capture new writings from this interface, since it is not desirable for the erased writings to re-appear in the shared virtual model contents at a later time.

If the participant using the erasure tool is attempting to remove markings that were made, at least in part, on a surface other than the one on which the eraser tool is currently being applied, then it is desirable, but not necessary, that that participant as well as other participants be able to physically or digitally erase the markings on these other input interfaces, so that they do not unduly distract the participants or potentially confuse any cameras that observe them for the purpose of capture.

Other embodiments of the invention provide methods of erasure that do not require a tool. In some of these embodiments, participants may erase contents of the shared virtual model by physically or digitally erasing the corresponding markings from the input interfaces from which they came. For instance, the participant may simply use either a standard whiteboard eraser, a cloth, or his hand to erase markings he made earlier on a whiteboard, and these markings would disappear from all displays of the shared virtual model contents. Similarly, a participant who drew with a pencil on his input interface may erase the pencil markings to remove his inputs from the shared virtual model. In these examples, the camera and analyzer observing an input interface detect the absence of the erased markings, and remove the corresponding contributions from the contents of the shared virtual model that is shown on all displays.

In still other embodiments of the invention, gestural controls are used to erase portions of the shared virtual model, as previously discussed. These embodiments operate similarly to those that rely on use of a physical tool, except that instead of detecting and tracking a visually-salient tool, they recognize and track the silhouette and/or appearance of a hand and/or writing instrument against the background of a physical writing surface. For example, the participant may extend a finger, touch a point on the board, and hold it there for a sufficient amount of time for the camera to detect the extended finger in the silhouette. Upon detection, an image of an eraser object can be projected onto the display. Then, as the participant moves his hand, the system tracks the movement and updates the projected location of the eraser object, while simultaneously removing shared virtual model contents that are virtually erased.

Whiteboard Content History

Embodiments of the present invention maintain in memory not just the current shared virtual model contents, but also a history of the changes made to the shared virtual model contents over time. This history may be stored as a series of time-stamped or time-ordered images showing the state of the shared virtual model contents at different times during a virtual collaboration session. For example, the history is more compactly stored as a series of vectors indicating where and when marks were made on the board. Vector data may be stored in a number of ways that are known in the art. For example, each vector may consist of an origin coordinate, an end coordinate, a color, and a timestamp. Each coordinate has as many components as there are dimensions in the reference coordinate space of the shared virtual model contents. In addition, each vector may be associated with the source input interface that generated it, so that marks made via one or more input interfaces may be grouped and treated differently than marks made via one or more of the other input interfaces.

The history allows participants to perform a number of useful operations. For example, the most recent one or more changes made to the shared virtual model can be undone. Also, the currently displayed contents of the shared virtual model can be displayed with an image of the shared virtual model at an earlier time. In addition, another embodiment distinguishes between marks made by different participant, such as through color coding. Also, the history allows for the replaying of the virtual collaboration session, by clearing the shared virtual model and re-drawing and erasing the marks made thus far in the order these changes were made. Further, a slider on a timeline can correspond to a time index. The display of the shared virtual model is updated as the slider is moved in order to reflect the state of the shared virtual model at the time corresponding to the current slider position.

All of these actions may be controlled through a separate interface, such as a computer with keyboard and mouse, through the participant's drawing of special symbols on the input interface, through camera-based recognition of gestures made by the participants, through visual tracking of special tools moved by the participants on the surface of an input interface, or through some combination of these.

In one embodiment, a timeline symbol is displayed somewhere on the input interface. This symbol appears as a straight horizontal line with arrowheads at both ends, and with one or more vertical tick marks along the line, all enclosed within a rectangular box. Positions along the line correspond to time, increasing from the start time of the virtual collaborative session (associated with the left arrowhead of the line) to the current time (associated with the right arrowhead). Initially, the line contains no tick marks, but participants may add them during the collaboration session. Whenever a tick mark is made by a participant (and therefore appears on the displays of all other participants), the current shared virtual model state and the current time are saved and are associated with this tick mark.

When the camera detects, via the camera-based gestural control interface discussed above, that a participant is using his pen to touch one of the tick marks for an extended time, the whiteboard is restored to the state associated with that tick mark. When the camera detects that a participant is using his pen to touch a timeline point other than a tick mark, the displays of the shared whiteboard are restored to reflect the contents corresponding with that time, where the time is estimated from the location of the timeline point relative to the tick marks or arrow heads to the left and right of it. For example, if the point is halfway between the left arrowhead and first tick mark, the displays of the whiteboard are restored to their contents at the time halfway between the start of the session and the time a participant first drew a tick mark.

Further, when the camera detects that a participant is using his pen to touch the left arrowhead, the whiteboard contents are undone in reverse order from the current time, at a speed faster than real time, effectively doing a fast rewind of the virtual collaborative session. As the rewind occurs, a special circular symbol is projected by the system onto the timeline to indicate the past point in time associated with what is currently displayed. The special symbol moves from right to left along the timeline as the rewind occurs. Similarly, when the camera detects that a participant is using his pen to touch the right arrowhead of the timeline, a fast-forward from some previous point in time is executed.

Other types of history-based operations, such as those listed earlier, may be controlled via similar interaction of camera-based gestural control with known symbols displayed on the input interfaces. While any of these history-based operations are being done, the effective clock of the system is frozen, so that the system does not associate the history of the shared virtual model being reviewed with the current time.

Virtual Laser Pointer

In an embodiment of the present invention, laser pointers may be used to interact with the input interface. More specifically, the cameras directed at the physical writing surfaces of the input interface may not only detect the writings and erasures of the participants, but may also track the motion of the spots of light projected by conventional laser pointers onto these surfaces. Many methods are known in the art for tracking laser pointer light with cameras. Typically, these methods analyze the video obtained from the camera for isolated, moving spots having a color within a specific range of colors known to be associated with the laser pointers in use with the system. These spots are detected and tracked in a series of video frames.

In some embodiments of the invention, the laser pointers may be used as an instrument for writing to the input interface. The location and motion of the laser pointer light is detected and measured to estimate the trajectory of the laser pointer. Light on the surface is interpreted as a mark made on the surface. This mark is added to the contents of the shared virtual model, and re-projected onto all displays in use by the participants.

In some embodiments of the invention, these marks are not added permanently to the contents of the shared virtual model, but are instead added for a short amount of time. This simulates the use of a virtual laser pointer whose projected light appears on all displays of the shared virtual model. The marks made by the laser pointer are only temporary in all displays, and are therefore more useful as a means for drawing attention to selected parts of the shared virtual model without permanently altering it, in much the same way that a computer mouse might be moved around a computer display. For example, a participant may use light from a laser pointer to make a motion that circles around some part of a physical whiteboard, underlines some part of it, or crosses out some part of it. Alternatively, the laser pointer may simply hover around some location on the shared virtual model, or make some other motion. These motions are captured by one of the cameras of the system, and appear as circles, underlining, cross-outs, hovering dots, or other shapes for a short amount of time (e.g., 3 seconds or less) on all the displays watched by participants. In this way, a first person controlling the laser pointer can bring attention to or otherwise gesture about some part of the contents of the shared virtual model in such a way that is visible not only to other participants watching the same display and physical laser pointer as him, but also to other participants watching other displays, perhaps at other physical sites. This is done without necessitating that the first person permanently modify the contents of the shared virtual model.

Accordingly, the present invention provides a method and system for providing communication through shared media. In particular, embodiments of the present invention are capable of implementing shared communication platforms through interfaces that do not require participants to bring specialized equipment to a communication session and/or do not require participants to have special skills. That is, the participants need only come to their respective meeting locations with a pen and paper, for example. As a result, embodiments of the present invention provide for natural interfaces in implementing the shared communication platform or media. As an added benefit, embodiments of the present invention are scalable because of the editing process implemented to reduce visual feedback information. As a result, embodiments of the present invention satisfactorily provide an input interface for participants to make contributions to a shared communication platform.

While the methods of embodiments illustrated in flow charts 200 and 400 show specific sequences and quantities of steps, the present invention is suitable to alternative embodiments. For example, not all the steps provided for in the methods are required for the present invention. Furthermore, additional steps can be added to the steps presented in the present embodiment. Likewise, the sequences of steps can be modified depending upon the application.

The preferred embodiment of the present invention, a method and system for providing communication through shared media, is thus described. While the present invention has been described in particular embodiments, it should be appreciated that the present invention should not be construed as limited by such embodiments, but rather construed according to the below claims.

What is claimed is:

1. A method for communicating through shared media, comprising:
accessing a plurality of images from respective input interfaces of a plurality of input interfaces, wherein at least one of said plurality of images is captured using a camera, and wherein at least one of said plurality of images contains a respective form of communication;
extracting said respective form of communication from said plurality of images;
constructing a respective appearance model corresponding to each of said plurality of input interfaces, wherein at least one of said respective appearance models contributes said respective form of communication that is extracted and transformed to a reference frame of a reference coordinate system;
combining said respective appearance models together to generate a shared virtual model; and
displaying said shared virtual model to at least one output medium.

2. The method of claim 1, wherein said displaying said shared virtual model further comprises:
superimposing said shared virtual model onto at least one of said plurality of input interfaces.

3. The method of claim 2, further comprising:
extracting selected contributions that are non-communicative from a selected input interface;
removing said selected contributions that are non-communicative from said shared virtual model so that said selected contributions that are non-communicative are not superimposed onto said selected input interface.

4. The method of claim 1, wherein at least one of said plurality of images comprises a video stream.

5. The method of claim 1, wherein said constructing a respective appearance model further comprises:
modeling and removing the background from at least one of said plurality of images.

6. The method of claim 1, wherein said output medium comprises a projector.

7. The method of claim 1, further comprising:
tracking a selected input interface;
adjusting output images associated with said selected input interface from at least one projector system to align with positioning of said selected input interface.

8. The method of claim 1, wherein said combining of said respective appearance models comprises:
layering at least two of said respective appearance models to generate said shared virtual model.

9. The method of claim 8, further comprising:
capturing a new image;
constructing a new layer containing said new image; and
layering said new layer with at least one of said respective appearance models that are layered to generate said shared virtual model.

10. The method of claim 1, further comprising:
detecting a boundary of an input interface to define a corresponding input interface coordinate system.

11. The method of claim 1, further comprising:
separately recording each of said respective appearance models over time; and
recording said shared virtual model over time.

12. The method of claim 11, further comprising:
navigating through a history of said shared virtual model.

13. The method of claim 1, further comprising:
erasing some forms of communication on an input interface; and
manifesting this erasure onto displays of said shared virtual model.

14. The method of claim 1, further comprising:
updating a new form of communication in said respective appearance model when said new form of communication remains static for a period of time.

15. The method of claim 1, further comprising:
enhancing the appearance of at least one of said respective forms of communication in at least one output medium displaying said shared virtual model.

16. The method of claim 1, further comprising:
recognizing a gesture made by a participant in said plurality of images as a control mechanism.

17. The method of claim 1, further comprising:
recognizing a laser pointer light on at least one of said plurality of input interfaces; and
displaying transient forms of communication in at least one of said output medium displaying said shared virtual model based on recognizing said transient forms of communication.

18. The method of claim 1, further comprising:
recognizing digitized forms of communication as inputs to said shared virtual model.

19. A system for communicating through shared media, comprising:
an extractor adapted to receive a plurality of images from respective input interfaces of a plurality of input interfaces captured from at least one camera system, wherein at least one of said plurality of images contributes forms of communication to a shared virtual model, and wherein at least one of said plurality of images is captured using a camera, said extractor for extracting said forms of communication from each of said plurality of images;
an analyzer coupled to said extractor for constructing a respective appearance model corresponding to each of said plurality of input interfaces, wherein at least one of said respective appearance models contributes respective forms of communication that are transformed to a reference frame of a reference coordinate system;
an aggregator coupled to said analyzer for combining each of said respective appearance models together to generate said shared virtual model.

20. The system of claim 19, wherein said extractor extracts selected non-communicative contributions from an image associated with a selected input interface; and wherein said system further comprises a remover coupled to said aggregator for removing said selected non-communicative contributions from said shared virtual model so that said selected non-communicative contributions are not superimposed onto said selected input interface.

21. The system of claim 19, further comprising:
at least one projector system coupled to said aggregator for projecting said shared virtual model to at least one of said plurality of input interface.

22. The system of claim 21, wherein said at least one projector system comprises:
a single projector projecting said shared virtual model to multiple input interfaces.

23. The system of claim 21, wherein said at least one projector system comprises:
multiple projectors projecting said shared virtual model to a single input interface.

24. The system of claim 19, wherein said plurality of input interfaces is located at a single site.

25. The system of claim 19, wherein said plurality of input interfaces is distributed across at least two or more sites.

26. The system of claim 19, further comprising:
a tracker coupled to said at least one camera system for tracking an input interface to enable images associated with said input interface to be captured successively by at least two camera systems.

27. The system of claim 19, further comprising:
a tracker coupled to said at least one camera system for tracking an input interface to enable said shared virtual model to be projected to said input interface successively by at least two projector systems.

28. The system of claim 19, wherein at least one camera system comprises:
multiple camera systems capturing an image from a single input interface.

29. The system of claim 19, wherein at least one camera system comprises:
a single camera system capturing images from multiple input interfaces.

30. A computer system comprising a processor and a computer readable memory coupled to said processor and comprising program instructions that, when executed, implement a method for communicating through shared media, comprising:
accessing a plurality of images from respective input interfaces of a plurality of input interfaces, wherein at least one of said plurality of images is captured using a camera, and wherein at least one of said plurality of images contains a respective form of communication;
extracting said respective form of communication from said plurality of images;
constructing a respective appearance model corresponding to each of said plurality of input interfaces, wherein at least one of said respective appearance models contributes said respective form of communication that is extracted and transformed to a reference frame of a reference coordinate system;
combining said respective appearance models together to generate a shared virtual model; and
displaying said shared virtual model to at least one output medium.

31. The computer system of claim 30, wherein said displaying said shared virtual model further comprises instructions for performing:
superimposing said shared virtual model onto at least one of said plurality of input interfaces.

32. The computer system of claim 31, wherein said computer readable memory further comprises instructions for performing:
extracting selected contributions that are non-communicative from a selected input interface;
removing said selected contributions that are non-communicative from said shared virtual model so that said selected contributions that are non-communicative are not superimposed onto said selected input interface.

33. The computer system of claim 30, wherein at least one of said plurality of images comprises a video stream.

34. The computer system of claim 30, wherein said constructing a respective appearance model in said computer readable memory further comprises instructions for performing:
modeling and removing the background from at least one of said plurality of images.

35. The computer system of claim 30, wherein said output medium comprises a projector.

36. The computer system of claim 30, wherein said computer readable memory further comprises instructions for performing:
tracking a selected input interface;
adjusting output images associated with said selected input interface from at least one projector system to align with positioning of said selected input interface.

37. A computer readable medium containing program instructions that implements a method for communicating through shared media, comprising:
accessing a plurality of images from respective input interfaces of a plurality of input interfaces, wherein at least one of said plurality of images is captured using a camera, and wherein at least one of said plurality of images contains a respective form of communication;
extracting said respective form of communication from said plurality of images;
constructing a respective appearance model corresponding to each of said plurality of input interfaces, wherein at least one of said respective appearance models contributes said respective form of communication that is extracted and transformed to a reference frame of a reference coordinate system;
combining said respective appearance models together to generate a shared virtual model; and
displaying said shared virtual model to at least one output medium.
